(19) United States
(12) Patent Application Publication
(10) Pub. No.: US 2025/0280787 A1
(43) Pub. Date: Sep. 11, 2025

(54) PLATFORM ASSEMBLY FOR PETS

(71) Applicant: Jules-Alexandre Jacques, Quebec (CA)

(72) Inventor: Jules-Alexandre Jacques, Quebec (CA)

(21) Appl. No.: 18/596,500

(22) Filed: Mar. 5, 2024

(51) Int. Cl. A01K 1/035; A01K 1/02

(52) U.S. Cl. CPC A01K 1/035; A01K 1/0272

(57) ABSTRACT

The present disclosure provides a platform assembly for providing a comfortable resting area for one or more pets, or non-living objects, while allowing accommodation of the pets in close proximity of a friendly human being in domestic as well as work environments. The platform assembly is adapted to be detachably mounted to various types of furniture or household appliances, and ensure that the pets present in the resting area feel the presence the friendly human being at all times.

### TECHNICAL FIELD

The present disclosure relates to the field of platforms for accommodating pets or non-living objects. More particularly, the present disclosure relates to a platform assembly for providing a resting area for one or more pets or non-living objects, which is configured to be detachably mounted to various types of furniture or household appliances.

### BACKGROUND

Background description includes information that may be useful in understanding the present invention. It is not an admission that any of the information provided herein is prior art or relevant to the presently claimed invention, or that any publication specifically or implicitly referenced is prior art.

Pets in a domestic environment are known to have improved morale, communication and relationship with human beings after such pets spend time with the human beings. Also, regular communication with pets facilitates reduction in stress and increase in productivity of human beings. However, for work environments such as office or a work-from-office setting, it is very difficult for a person to spend time with a pet in view of constant alertness and promptness of the person required for such environments. This lack of disposition or attention of the person towards the pet often leads to behavioral disorders in the pet. For example, when a person is extensively involved in the work environment, the person is unable to spend time with his/her pet, such as a cat or a dog, the pet is prone to experience separation anxiety disorders.

Pet hammocks are commonly known in the art for accommodating pets in a domestic environments or in vehicles. However, such pet hammocks do not address the above shortcoming of behavioral disorders in pets due to lack of communication or attention from a friendly human being. In addition, such pet hammocks have proven cumbersome and unwieldy and there has been a long-felt need for an improved pet hammock capable of being easily and detachably mounted to a furniture or a household appliance for providing a comfortable resting space to one or more pets, while ensuring that the pets resting in the pet hammock feel the presence a friendly human being in close proximity.

### OBJECTS OF THE PRESENT DISCLOSURE

Some of the objects of the present disclosure, which at least one embodiment herein satisfies are as listed herein below.

An object of the present disclosure is to provide a platform assembly for providing a comfortable resting area/space for one or more pets, or non-living objects.

Another object of the present disclosure is to provide a cost-efficient and portable platform assembly for accommodating pets in close proximity of a human being in both domestic as well as work environments.

Another object of the present disclosure is to provide a platform assembly configured to be detachably mounted to various types of furniture or household appliances in domestic and work environments.

Another object of the present disclosure is to provide a platform assembly for ensuring that pets present in a resting area thereof feel the presence a friendly human being in close proximity.

### SUMMARY

Aspects of the present disclosure relates to a platform assembly for accommodating pets, and capable of being easily and detachably mounted to a furniture or a household appliance for providing a comfortable resting space to the pets in close proximity of a friendly human being. In an aspect, the platform assembly includes a bed having a resting portion to accommodate one or more pets and a protruding handle extending in a direction away from the resting portion, and a clamp adapted to detachably mount the bed to a household. The clamp includes a body having an internal cavity for receiving at least one projection formed on the protruding handle. The internal cavity has a lateral slot adapted to receive a threaded fastener for controlling tightening of the protruding handle inside the internal cavity. The body includes a first portion and a second portion spaced apart from one another. The second portion includes a slot adapted to receive a leadscrew for movement towards and away from the first portion for fixedly gripping the household appliance between a first end of the leadscrew and the first portion of the body to enable mounting of the bed to the household appliance.

In an embodiment, the at least one projection may include a set of grooves adapted to engage corresponding set of slits formed in the internal cavity.

In an embodiment, the leadscrew includes the first end adapted to pass through a slot of the second portion, and a second end equipped with a handle to enable a user to control movement of the plug towards or away from the first portion of the body. The first end may have a plug attached thereto to enable gripping of the household appliance between the plug and the first portion of the body.

In an embodiment, the first portion may include a gripping surface formed of an elastomeric material for gripping a surface of the household appliance from above.

In an embodiment, the plug may be formed of an elastomeric material for gripping a surface of the household appliance from below.

In an embodiment, rotation of the threaded fastener allows the user to control tightening of the at least one projection of the protruding handle present inside the internal cavity.

In an embodiment, the household appliance may include any of a table, a chair, a window sill, a door and a vehicle seat.

In an embodiment, the bed may include a metal frame for supporting the resting portion while the bed is mounted to the household appliance. The resting portion may be formed of a fabric material.

In an embodiment, the resting portion may fully cover the metal frame to prevent the one or more pets from coming in contact with the metal frame. The metal frame may be formed in a circular shape.

In an embodiment, the resting portion may be installed to the metal frame to form a concave-shaped resting space for the one or more pets, when view from above.

In an embodiment, the first portion and the second portion may be spaced apart from one another in a vertical direction. The first portion and the second portion may extend from the body in a horizontal direction.

In an embodiment, rotation of the handle allows the user to control movement of the plug towards or away from the first portion.

In an embodiment, the platform assembly allows the user to place the one or more pets inside the resting portion of the bed and mount the bed to the household appliance while the user is engaged in an activity using the household appliance.

In an embodiment, the clamp allows mounting of the bed to the household appliance by rotating the handle attached to the second end of the leadscrew in a first direction to enable movement of the plug towards the first portion of the body of the clamp. In another embodiment, the clamp allows the user to detach the bed from the household appliance by rotating the handle in a direction opposite to the first direction to enable movement of the plug away from the first portion.

In an embodiment, the resting portion of the bed is adapted to receive and accommodate one or more non-living items.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A and 1B illustrate exemplary representations of a platform assembly configured to be detachably mounted to a furniture or a household appliance, in accordance with an embodiment of the present invention;

FIG. 2 illustrates a plan view of a bed of the platform assembly in accordance with an embodiment of the present invention;

FIGS. 3A to 3C illustrate various representations of a clamp of the platform assembly adapted for mounting the bed to a furniture or a household appliance, in accordance with an embodiment of the present invention; and

FIG. 4 illustrates a perspective view of a pet resting in the bed mounted on a furniture, in accordance with an embodiment of the present invention.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

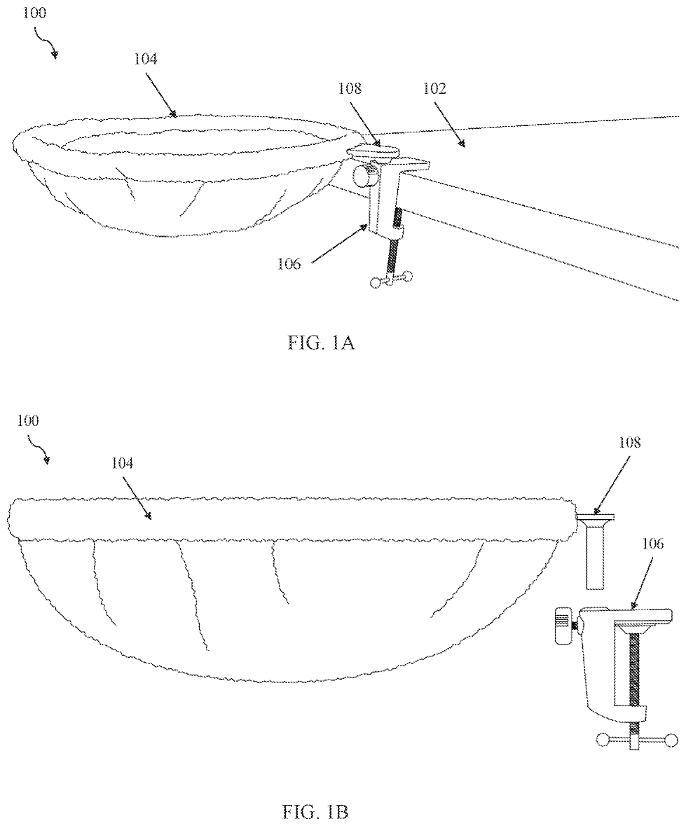

The present disclosure provides a platform assembly for accommodating pets, and capable of being easily and detachably mounted to a furniture or a household appliance for providing a comfortable resting space to the pets in close proximity of a friendly human being using the household appliance in a work or domestic environment. The platform assembly provides for accommodation or resting of one or more pets in vicinity of a friendly human being, even when the friendly human being is engaged in an activity related to domestic or work environment that requires complete attention of friendly human being. The platform assembly thus facilitates prevention of onset of behavioral disorders in the pets by ensuring that the pests are not devoid of communication with the friendly human being while the user is engaged in other activities, such as work or household chores. FIG. 1A illustrates a perspective view of a platform assembly 100 (also referred to as “pet hammock” hereinafter) configured to be detachably mounted to a furniture or a household appliance 102. FIG. 1B illustrates a front view of the platform assembly 100. The platform assembly 100 includes a bed 104 detachably mounted to the household appliance 102, such as a table, a chair, a window sill, a door, a vehicle seat etc.

The bed 104 is mounted to the household appliance 102 by a clamp 106 that allows mounting as well as removal of the bed 104 from the household appliance 102. The platform assembly 100 allows a user of the household appliance 102 to accommodate one or more domestic animals, such as canines, cats, rabbits, hamsters, birds, or other pets, in the bed 104 to enable such pets to feel the presence of the user, even when the user engages in an activity that required attention of the user. This prevents onset of behavioral disorders in the pets by ensuring that the pests are not devoid of communication with the user while the user is engaged in other activities, such as work or household chores. In an example, the platform assembly 100 may enable a user to accommodate pets in the bed 104 removably mounted to a seat of a vehicle, while the user is driving the vehicle.

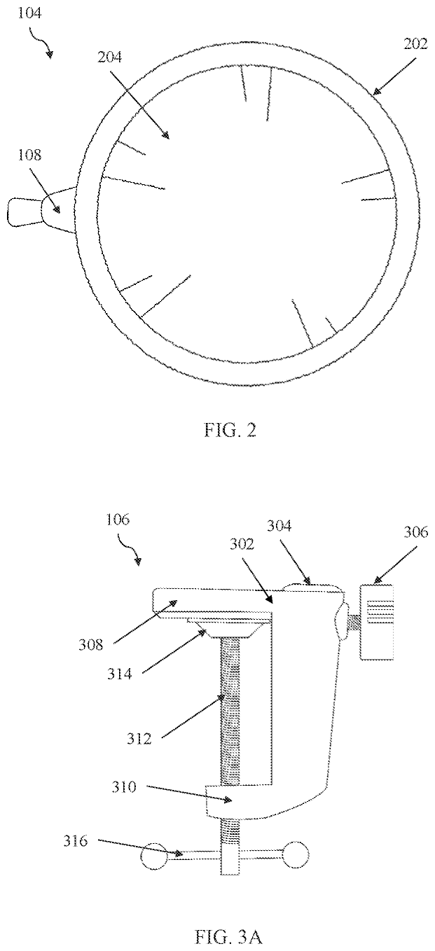

Referring to FIG. 2, where a plan view of the bed 104 is shown. The bed 104 may include a metal frame 202 and a resting portion 204 formed of a fabric material to allow a comfortable resting area to the pet. The resting portion 204 may be formed of a rabbit fur imitation fabric material. The resting portion 204 may fully cover the metal frame 202 to prevent the pet from coming in contact with the metal frame 202. In an example, the metal frame 202 may be formed in a circular shape with the resting portion 204 provided with the metal frame 202 to provide a concave-shaped resting space for the pet, when view from above. This configuration of the bed 104 ensures that the pet cannot easily fall out of the resting portion 204.

The metal frame 202 of the bed 104 may include a protruding handle 108 for coupling with the clamp 106. The protruding handle 108 may extend in a direction away from the resting portion 204, and may include one or more projections formed on an outer surface of the protruding handle 108 and adapted to be fixedly coupled to the clamp 106. The protruding handle 108 may allow a user to carry the bed 104 and couple the one or more projections to the clamp 106 for mounting the bed 104 to the household appliance 102.

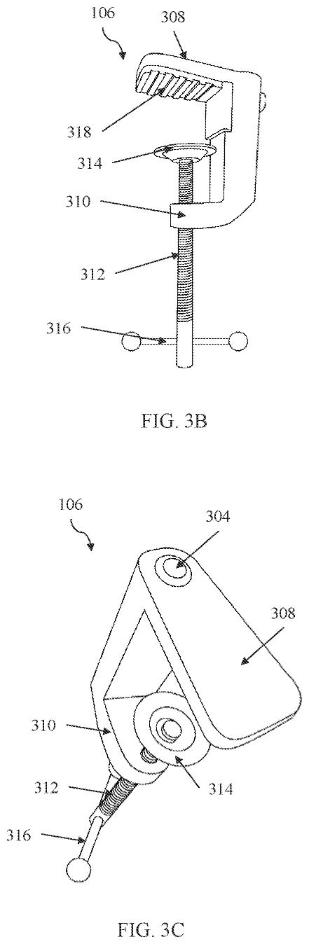

FIG. 3A shows a side view of the clamp 106, and FIGS. 3B and 3C illustrate perspective view of the clamp 106. The clamp 106 may include a body 302 having an internal cavity 304 adapted to receive at least one of the projections of the protruding handle 108 of the bed 104. In an example, the projection may include a set of grooves adapted to engage corresponding set of slits provided in the internal cavity 304, to enable falling out of the protruding handle 108 from the internal cavity 304, once inserted therein.

The internal cavity 304 may include a lateral slot configured to receive a threaded fastener 306 for controlling tightening, and prevent movement of the protruding handle 108 inside the internal cavity 304. A user may easily rotate the threaded fastener 306 in a clockwise or a counterclockwise direction while being inserted into the lateral slot to control tightening of the protruding handle 108 present inside the internal cavity 304. The body 302 may be formed of a metal or a fiber material to enhance rigidity thereof.

The body 302 of the clamp 106 may include a first portion 308 and a second portion 310 spaced apart from one another in a vertical direction. The first portion 308 and the second portion 310 may extend from the body 302 in a horizontal direction. The second portion 310 may include a slot adapted to receive a leadscrew 312 for movement towards and away from the first portion 308.

A first end of the leadscrew 312 may pass through the slot of the second portion 310, and may include a plug 314 formed of an elastomeric material capable of efficiently gripping a surface of the household appliance 102 through suction. A second end of the leadscrew 310 may be provided with a handle 316 to enable the user to control movement of the plug 314 towards or away from the first portion 310 of the clamp 106. In an example, a user may easily rotate the handle 316 in a clockwise or a counterclockwise direction to control movement of the plug 314 attached to the first end of the leadscrew 312. At least the first portion 308 may include a gripping surface 318 formed of an elastomeric material for efficiently gripping a surface of the household appliance 102, as shown in FIG. 3B. The pet hammock 100 allows the user to place one or more pets inside the resting portion 204 of the bed 104 and mount the bed 104 to the furniture or the household appliance 102 while the user is engaged in an activity using the household appliance 102. The clamp 106 allows mounting of the bed 104 to the household appliance 102 by simply rotating the handle 316 attached to the second end of the leadscrew 312 in a first direction to enable movement of the plug 314 towards the gripping portion 318 of the first portion 308 of the body 302 of the clamp 106. Similarly, the clamp 106 also allows the user to detach the bed 104 from the household appliance 102 by rotating the handle 316 in a direction opposite to the first direction to enable movement of the plug 314 away from the gripping portion 318 of the first portion 308.

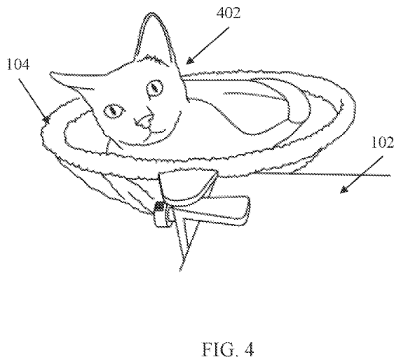

In an implementation shown in FIG. 4, a person/user may install the pet hammock 100 at an edge of a furniture or a household appliance 102, such as a table, and place a pet 402 in the bed 104 to enable the pest 402 to comfortably rest in the resting portion 204 of the bed 104 while the user utilizes the table for an activity, such as, working on a laptop/computer, preparing meals, studying a book, etc. The user may firstly couple the projection of the protruding handle 108 of the bed 104 to the clamp 106 by passing said projection into the internal cavity 304 and rotating the threaded fastener 306 to fixedly couple the protruding handle 108 to the clamp 106. Thereafter, the handle 316 attached to the second end of the leadscrew 312 may be rotated to control movement of the plug 314 towards the first portion 308 to enable an edge of the furniture 102 to be fixedly held/gripped between the plug 314 and the gripping surface 318 of the first portion 308. The pet 402 may then be placed into the resting portion 204 of the bed 104. Additionally or alternatively, one or more non-living objects, such as, toys, eatables, pillows, etc., may be placed in the resting portion 204 of the bed 104. Further, when required, the user may simply rotate the handle 314 in an opposite direction to detach the pet hammock 100 from the furniture 102. Thus, the pet hammock 100 is capable of providing a comfortable resting area of the bed 104 for one or more pets, or non-living objects, while allowing mounting of the bed 104 to different types of furniture or household appliances.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

1. A platform assembly, comprising:
a bed having a resting portion to accommodate one or more pets and a protruding handle extending in a direction away from the resting portion; and
a clamp adapted to detachably mount the bed to a household appliance, the clamp comprising a body having an internal cavity for receiving at least one projection formed on the protruding handle, the internal cavity having a lateral slot adapted to receive a threaded fastener for controlling tightening of the protruding handle inside the internal cavity,
wherein the body comprises a first portion and a second portion spaced apart from one another, the second portion including a slot adapted to receive a leadscrew for movement towards and away from the first portion for fixedly gripping the household appliance between a first end of the leadscrew and the first portion of the body to enable mounting of the bed to the household appliance, and wherein the first end comprises a plug formed of an elastomeric material, the plug configured to grip a surface of the household appliance through suction.

2. (canceled)

3. The platform assembly as claimed in claim 1, wherein the leadscrew comprises the first end adapted to pass through a slot of the second portion, and a second end equipped with a handle to enable a user to control movement of the plug towards or away from the first portion of the body.

4. The platform assembly as claimed in claim 3, wherein the first end has the plug attached thereto to enable gripping of the household appliance between the plug and the first portion of the body.

5. The platform assembly as claimed in claim 1, wherein the first portion has a gripping surface formed of an elastomeric material for gripping a surface of the household appliance from above.

6. The platform assembly as claimed in claim 1, wherein the plug enables gripping a surface of the household appliance from below.

7. The platform assembly as claimed in claim 3, wherein rotation of the threaded fastener enables the user to control tightening of the at least one projection of the protruding handle present inside the internal cavity.

8. The platform assembly as claimed in claim 1, wherein the household appliance comprises any of a table, a chair, a window sill, a door and a vehicle seat.

9. The platform assembly as claimed in claim 1, wherein the bed includes a metal frame for supporting the resting portion while the bed is mounted to the household appliance.

10. The platform assembly as claimed in claim 1, wherein the resting portion is formed of a fabric material.

11. The platform assembly as claimed in claim 9, wherein the resting portion fully covers the metal frame to prevent the one or more pets from coming in contact with the metal frame.

12. The platform assembly as claimed in claim 9, wherein the metal frame is formed in a circular shape.

13. The platform assembly as claimed in claim 9, wherein the resting portion is installed to the metal frame to form a concave-shaped resting space for the one or more pets, when viewed from above.

14. The platform assembly as claimed in claim 1, wherein the first portion and the second portion are spaced apart from one another in a vertical direction.

15. The platform assembly as claimed in claim 1, wherein the first portion and the second portion extend from the body in a horizontal direction.

16. The platform assembly as claimed in claim 3, wherein rotation of the handle enables the user to control movement of the plug towards or away from the first portion.

17. The platform assembly as claimed in claim 3, wherein the platform assembly allows the user to place the one or more pets inside the resting portion
